(19) United States
(12) Patent Application Publication
(10) Pub. No.: US 2003/0165642 A1
(43) Pub. Date: Sep. 4, 2003

(54) Bead working tray with plastic scoop

(76) Inventor: Vicki Anne Day, Branson, MO (US)

Correspondence Address: Vicki Anne Day, P.O. Box 7096, Branson, MO, 65615, US

(21) Appl. No.: 10/338,618

(22) Filed: Jan. 8, 2003

Related U.S. Application Data
(60) Provisional application No. 60/348,045, filed on Jan. 11, 2002.

(51) Int. Cl. A01N 1/00

(52) U.S. Cl. 428/15

(57) ABSTRACT

The Bead Working Tray is made of a laminate surfaced material and trimmed in wood. Grooves are routed into the surface of the material. A smooth surface is created on the substrate as each groove is routed. Each groove is rounded on the bottom and at both ends. ⅛ inch of the wood trim extends above the surface of the tray to prevent beads from sliding off the surface of the tray. A plastic scoop is provided to facilitate in the transfer of beads to and from the tray. As beading artist gently slides the scoop across the bottom of a groove, the sides and bottom of the scoop mimic the shape of the groove. The scoop effortlessly gathers up all of the beads contained within each groove. The beads are held securely within the walls of the scoop and can then be transferred back to their original storage containers.

### (B) CROSS REFERENCE TO RELATED APPLICATIONS

Provisional Patent Application No. 60/348,045

Filing Date Jan. 11, 2002

### (C) STATEMENT REGARDING FEDERALLY SPONSORED RESEARCH OR DEVELOPMENT

Not applicable

### (D) REFERENCE TO A “MICROFICHE APPENDIX.”

Not applicable

### (E) BACKGROUND OF THE INVENTION

(1) Field of the Invention: Arts and Crafts

I am a long-standing artist and avid beader. I create, among other things, handmade books and embellish the covers with beads. Upon completion of an art project, like most other beading artists, I would spend countless hours sorting beads and beading materials in order to return them to their various storage containers for future use.

At the conclusion of a book commission in the fall of 2001, I was determined to create some process by which I could translate countless hours of nonproductive time in the sorting of beads and bead materials into productive and creative time. It meant not only creating some physical means of keeping beads sorted and separated during an art project but, equally important, devising an efficient and effective way of transferring beads back into their respective containers at the conclusion of a project.

My father is a woodworker and I have a good working knowledge of tools, wood and wood products. As a result, I was able to both design and assist in the manufacture of our bead working trays for the beading industry.

(2) Description of Related Art

I am currently aware of only two products in the market place that somewhat assist the beader in keeping beads separated during a beading project. However, none of these products provide an efficient and effective way to transfer the beads and/or beading materials from the tray back to their original storage containers.

(a) The first product is a circular, lightweight molded plastic dish measuring approximately six inches in diameter. The dish is divided into eight sections and a shallow, slightly rounded plastic ridge separates the sections from one another. The inherent problems with this product are:

(1) The static electricity created as a result of the plastic properties of the dish and its ridges cause the beads to jump erratically and move across the surface of the dish.

(2) The plastic dish is too lightweight. When the dish is even slightly jostled, the beads will spill outside the perimeter of the dish onto the table surface and/or floor.

(3) The shallow partitions that separate the sections are completely ineffective. Any usual and/or customary movement of the dish during a beading project causes the beads to roll over the shallow partitions and spill into the neighboring sections rendering the advantages of the separate sections of the dish completely ineffective.

(4) There is no efficient or effective way to remove the beads from any specific section without the beads becoming co-mingled.

(b) The second product is a rectangular, lightweight, molded plastic tray that contains a large oval indentation in its center where the beading artist can layout beads and beading materials in the creation a necklace. The inherent problems with this product are:

(1) There are an insufficient number of separate areas in which to store the beads required for a project. Although the tray has ample surface area to layout a necklace, there are only four recessed areas for bead storage within the remaining portion of the tray.

(2) All of the beads and bead materials required for the construction of the necklace are co-mingled within the four available recessed areas.

(3) The recessed areas are poorly designed in that the walls are straight and right-angled at the bottom.

(4) As a direct result of the design flaws of the recessed areas, it is difficult to remove the beads at the conclusion of the project.

### (F) BRIEF SUMMARY OF THE INVENTION

The bead working tray is made of a laminate material and trimmed in oak. Grooves are routed into the surface of the laminate. The depth of the grooves enables the beads to remain sorted and separated throughout an entire beading project. The oak trim extends above the surface of the tray thereby preventing beads and/or beading materials from sliding off the surface of the tray.

I also created a small, flexible plastic scoop to facilitate in the easy and rapid transfer of the beads to and from the tray. The beader gently slides the plastic scoop across the bottom of the groove and the beads within the groove are easily gathered into the scoop. The beads and/or beading materials can then be transferred back into their original storage containers.

None of the unique advantages of my bead working tray and the accompanying plastic scoop are available on either of the two competitor's products.

### (G) BRIEF DESCRIPTION OF THE SEVERAL VIEWS OF THE DRAWING(S)

Drawing 1: Typical Groove and Wood Trim

Cross section of a portion of a tray(s) that reflects the inside dimensions of the grooves that are routed in the laminate surfaced material and substrate, and the wood trim that surrounds the perimeter of the tray.

Drawing 2: Project Working Tray

Top view of Project Working Tray that reflects 36 grooves for beads and/or beading materials, one long needle groove, and wood trim around the perimeter of the tray.

Drawing 3: Class Working Tray

Top view of Class Working Tray that reflects 18 grooves for beads and/or beading materials and wood trim around the perimeter of the tray.

Drawing 4: Standard Working Tray

Top view of Standard Working Tray that reflects 18 grooves for beads and/or beading materials, one longer groove for needles, wood trim around the perimeter of the tray, and 18 holes for insertion of one-ounce plastic vials for bead storage.

Drawing 5: Combo Working Tray

Top view of Combo Working Tray that reflects two sizes of grooves to accommodate various sizes of beads and/or beading materials: 12 standard grooves and 18 large grooves; wood trim around the perimeter of the tray, 12 holes for insertion of one-ounce vials for bead storage and 18 holes for insertion of four-ounce plastic vials for bead storage.

Drawing 6: Plastic Scoop

FIG. 1: Top view of clear, transparent plastic rectangular blank to be used in the construction of the scoop.

FIG. 2: Side view of constructed Plastic Scoop that has been folded, creased and stapled, together with protective adhesive dot covering staple.

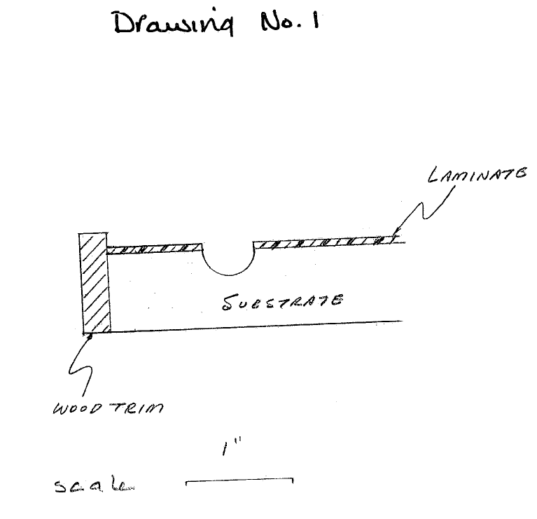

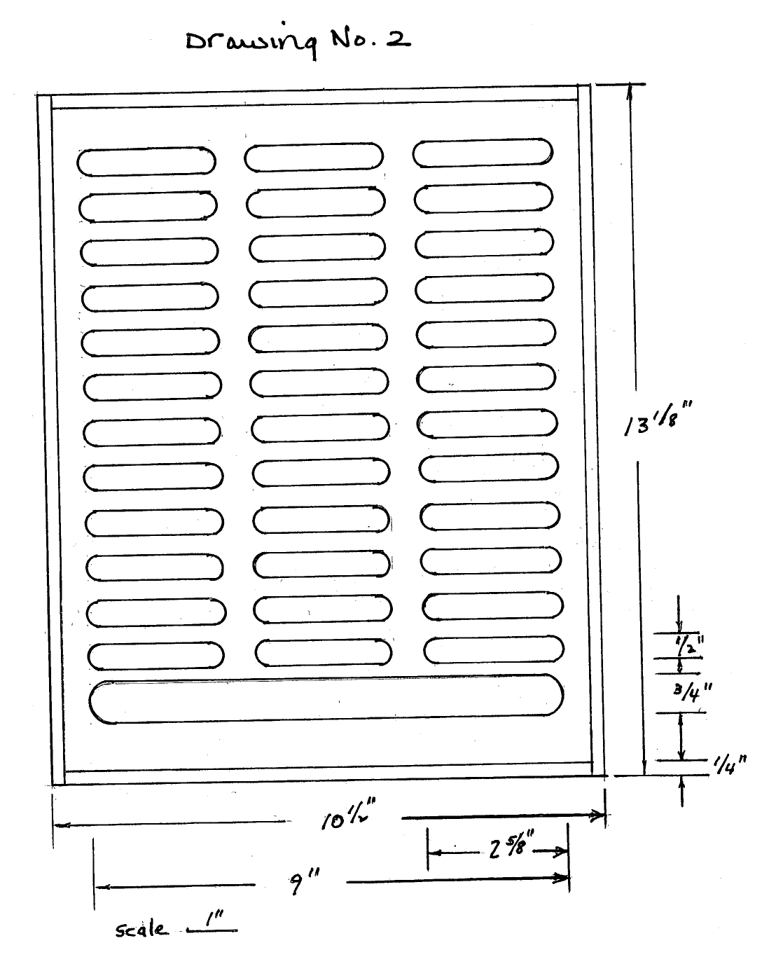

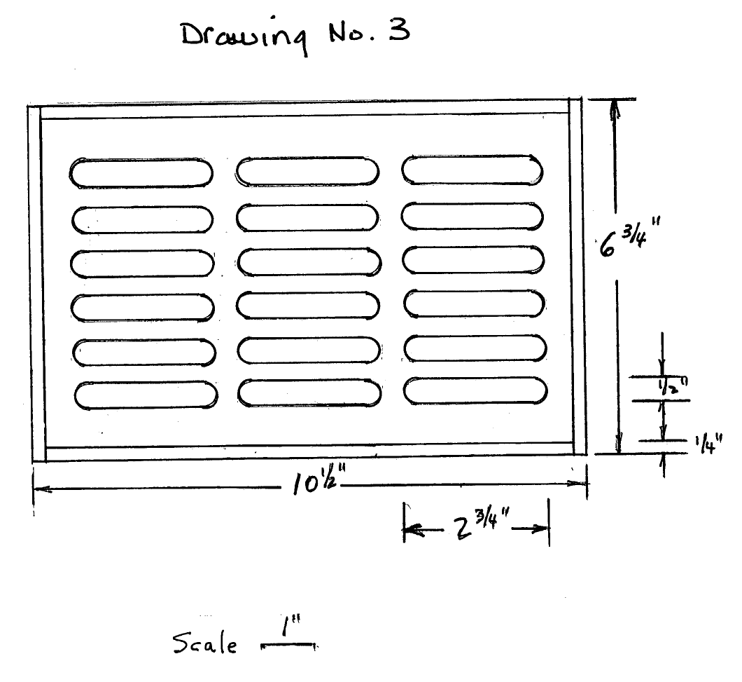

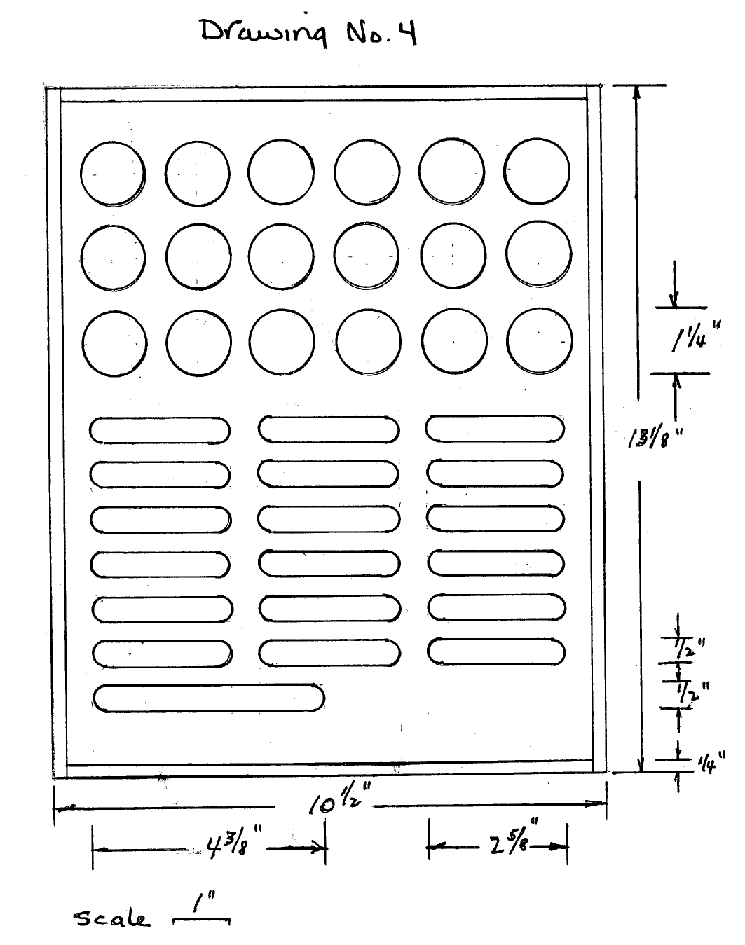

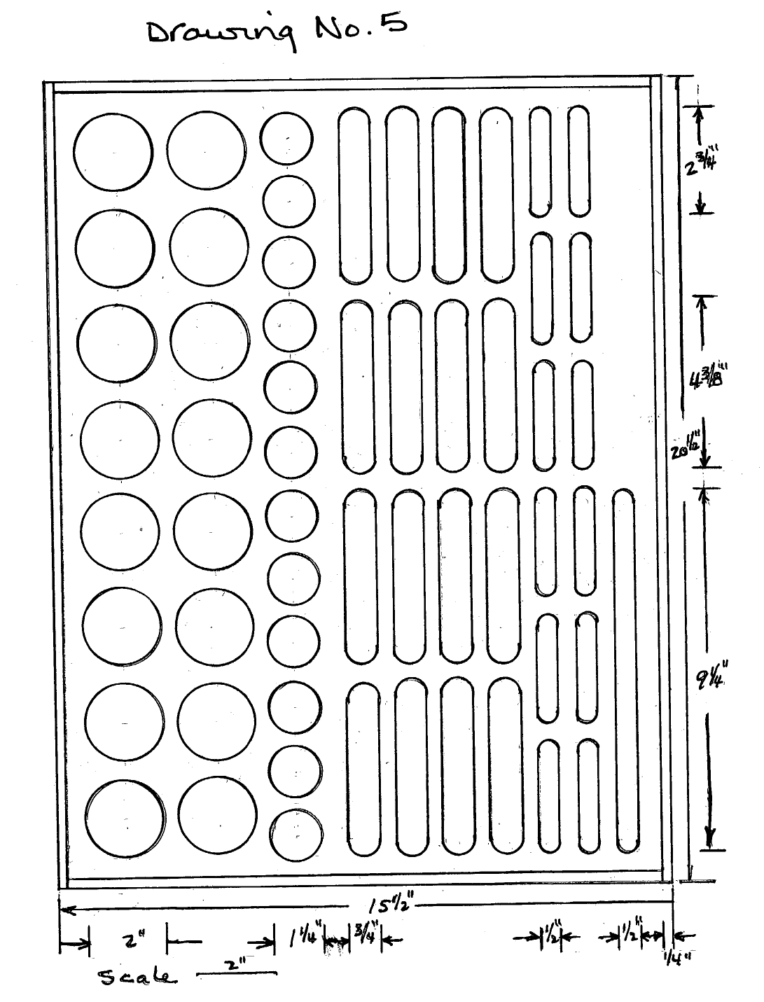

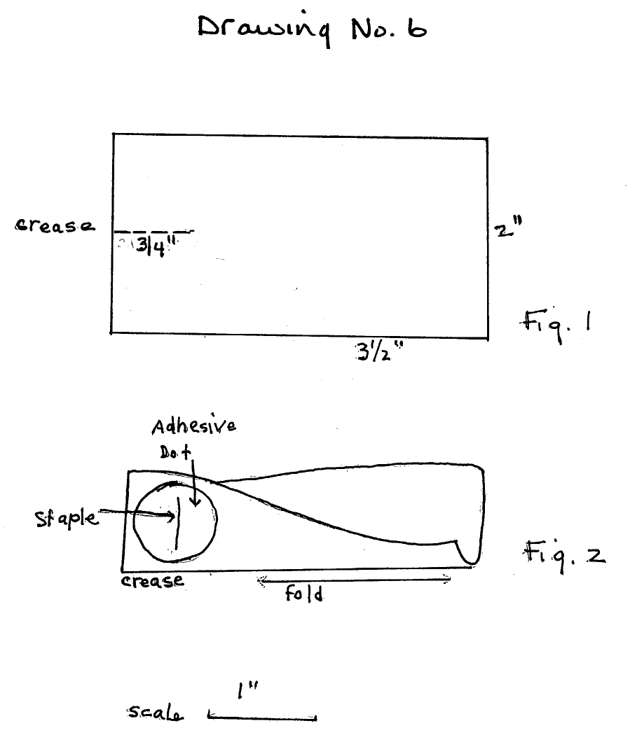

### (H) DETAILED DESCRIPTION AND SPECIFICATION OF THE INVENTION

### (1) Description of the Invention

The bead working tray is made of a laminate material and is trimmed in oak. Grooves are routed into the surface of the laminate. The unique properties of the laminate surfaced material and the wood trim are ideal in the use of the routed bead working tray. A smooth surface is created on the substrate as each groove is routed. Each groove is rounded on the bottom and at both ends. The depth of the grooves enables the beads to remain sorted and separated throughout an entire beading project. Additionally, the weight of the oak-trimmed laminate tray combined with the depth of the grooves allows the tray to be jostled and the beads will remain safely contained within each groove. ⅛ inch of the oak trim extends above the surface of the tray thereby preventing other beads and/or beading materials from sliding off of the surface of the tray. The beading artist uses the tip of a beading needle to pick up beads from any one of the grooves containing beads throughout the course of the project.

I also created a small, flexible plastic scoop to facilitate in the easy and rapid transfer of the beads to and from the tray at the beginning and conclusion of the beading project. Two plastic scoops are provided with each bead working tray. As the beading artist gently slides the flexible plastic scoop across the bottom of a groove, the sides and bottom of the plastic scoop mimic the shape of the groove. As a result, the plastic scoop effortlessly gathers up all of the beads contained within each groove. The beads and/or beading materials are held securely within the walls of the scoop and can then be transferred back into their original storage containers.

None of the unique advantages of my bead working tray and the accompanying plastic scoops are available on any of my competitors' products.

### (2) Process of Making the Invention

Bead Working Tray

(a) A sheet of ¾ inch thick laminate surfaced material is cut down with a table saw to create multiple blanks for one of the following bead working trays: (i) Project Working Tray (grooves only); (ii) Class Project Tray (grooves only); (iii) Combo Working Tray (grooves and vials for bead storage); (iv) Standard Working Tray (grooves and vials for bead storage); or (v) a tray with unique dimensions and specifications to fill a custom order from a bead store or beading instructor (grooves only or grooves and vials).

(b) The laminate blank is inserted into a custom jig necessary to create one of the trays listed in paragraph (H)(2)(a)(i-v) above, and the appropriate number and placement of grooves are routed.

(c) If we are creating a Combo Working Tray or a Standard Working Tray, (H)(2)(a)(iii-iv) respectively, the blank is removed from the routing jig and placed in a custom jig for use at the drill press. These two bead working trays also accommodate vials for storage of beads. Depending upon the tray, two sizes of holes measuring ½ inch in depth and squared at the bottom are drilled into the top section of the laminate blank above the portion that has been routed to hold the beads. Four-ounce and/or one-ounce vials are provided with these trays.

(d) Boards of solid oak are cut with the table saw and planed to create the oak trim. Trim is cut in various lengths depending upon the dimensions of the bead working tray, but are all uniform in width (¼ inch) and height (15/16 inch.)

(e) Tung oil is applied to all surfaces of the oak trim and allowed to dry.

(f) Oak trim is attached to all sides of the laminate surfaced material with metal brads and glue, and sanded as necessary

(g) When all four pieces of the trim are attached to the bead working tray, a ⅛-inch ledge of oak trim is created above the surface of the tray that prevents needles, beads and/or beading materials from spilling off the surface of the tray.

(h) Solvent and compressed air are used as necessary to clean the bead working tray.

(i) The finished trays are grouped by specific style and stored in custom boxes until an order is filled.

Plastic Scoop that Accompanies the Bead Working Tray

(j) A sheet of clear, transparent plastic (Example: document cover available at local office supply store) is cut down with a paper cutter to create multiple rectangular blanks. Each blank measures 2 inches wide by 3½ inches long.

(k) A rectangular plastic blank is gently folded lengthwise. Be careful not to create a crease along the 3½ inch folded edge. The scoop will now measure 1 inch wide by 3½ inches long.

(l) While holding the corners of one end of the scoop firmly together, begin at one end of the scoop and create a ¾ inch crease along the 3½ inch folded edge.

(m) In order for the beads to remain secure within the walls of the scoop, the end of the scoop must be permanently closed. Place a staple ⅝ inch from the end of scoop directly above the crease. The staple will be parallel to the end of the scoop and perpendicular to the ¾ inch creased edge.

(n) Cover the staple on each side of scoop with a ¾ inch round, colored adhesive dot. When using the scoop, the dots create a protective covering over the staple. When not in use, the colored dots allow the beading artist to more easily locate the plastic scoop.

### (3) Specification and Use of Invention

(a) The beading artist holds the plastic scoop in one hand and places the thumb and index finger above the folded edge and near the open end of the scoop. The scoop is used to transfer the beads and/or beading materials from their individual storage contains into the grooves provided on the bead working tray.

(b) The beading artist uses the tip of any sized beading needle to pick up beads directly from the grooves as the beading project is created.

(c) The depth of the grooves enables the beads to remain safely sorted and separated throughout an entire beading project.

(d) The properties of the laminate and substrate material do not create static electricity when the bead working tray is routed. Therefore, the beads remain undisturbed within each groove.

(e) The weight of the oak-trimmed laminate tray combined with the depth of the grooves allows the tray to be jostled and the beads will remain safely contained within each groove.

(f) The ⅛ inch of the oak trim that extends above the surface of the tray prevents beads and/or beading materials from sliding off the surface of the tray.

(g) At the conclusion of a project, the beading artist uses the plastic scoop to transfer the beads and/or beading materials from the grooves back into their original storage containers. The beading artist holds the flexible plastic scoop in one hand and positions the index finger of the opposite hand at the end of the groove containing the beads to be collected. As the flexible plastic scoop gently slides across the bottom of the groove, the sides and bottom of the scoop mimic the shape of the groove. As a result, the plastic scoop effortlessly gathers up all of the beads contained within the groove. The beads and/or beading materials are held securely within the walls of the scoop and the index finger of the opposite hand acts to cap off the open end of the bead-filled scoop. Remove the index finger from the open end of the scoop and pour the beads back into their original storage containers. Because the beads remain separated and sorted throughout the entire beading project, the lengthy process of sorting beads that once required hours or days of nonproductive time is now completely eliminated. The entire clean up process is effortless, efficient and can be accomplished within a matter of minutes.

1: I claim that the unique properties of the laminate-surfaced material and the wood trim are ideal in the use of the routed bead working tray.

2: I claim that the ⅛ inch of oak trim that extends above the surface of the bead working tray prevents beads and/or beading materials from sliding off the surface of the tray.

3: I claim that the properties of the laminate and substrate material do not create static electricity; therefore, the beads will remain undisturbed on the surface of the tray and within each groove.

4: I claim that the weight of the oak-trimmed laminate bead working tray allows the tray to be jostled and the beads will remain safely contained within each groove.

5: I claim that the grooves routed into the laminate-surfaced bead working tray enable the beads to remain sorted and separated throughout the beading project.

6: I claim that the depth of the grooves allows the tray to be jostled and the beads will remain safely contained within each groove.

7. I claim that a smooth surface is created on the substrate as each groove is routed.

8. I claim that the beading artist can use the tip of any sized beading needle to pick up beads from any one of the grooves throughout the entire beading project.

9. I claim that the flexible plastic scoop facilitates in the efficient transfer of beads to and from the grooves of the bead working tray.

10. I claim that the flexible plastic scoop effortlessly gathers the beads contained within the groove because the sides and bottom of the scoop mimic the shape of the groove as the beading artist gently slides the scoop across the bottom of the groove.
